(19) United States
(12) Patent Application Publication
(10) Pub. No.: US 2016/0227540 A1
(43) Pub. Date: Aug. 4, 2016

(54) SOFT BUFFER MANAGEMENT FOR ENHANCED CARRIER AGGREGATION

(71) Applicant: QUALCOMM Incorporated, San Diego, CA (US)

(72) Inventors: Wanshi Chen, San Diego, CA (US); Peter Gaal, San Diego, CA (US); Jelena Damnjanovic, Del Mar, CA (US)

(21) Appl. No.: 15/008,852

(22) Filed: Jan. 28, 2016

Related U.S. Application Data
(60) Provisional application No. 62/110,236, filed on Jan. 30, 2015.

(51) Int. Cl. H04W 72/04

(52) U.S. Cl. CPC H04W 72/0453

(57) ABSTRACT

Methods, systems, and devices for wireless communication are described. A user equipment (UE) may determine a reference number for component carriers (CCs) for partitioning a soft buffer when the number of the CCs configured for carrier aggregation (CA) operation exceeds a threshold. For example, the reference number of CCs may be associated with the soft buffer size or the category of the UE. The UE may allocate the soft buffer based on a comparison between the reference number of CCs and the number of the CCs. The UE may utilize portions of the soft buffer with different CCs based, for example, on the reference number of CCs and the status of the corresponding hybrid automatic repeat request (HARQ) processes. The UE may store a set of log-likelihood ratios (LLRs) for each HARQ process in the corresponding portions of the soft buffer. In some examples, CCs may be configured into priority groups with weighting factors for soft buffer partitioning.

### CROSS REFERENCES

The present Application for Patent claims priority to U.S. Provisional Patent Application No. 62/110,236 by Chen et al., entitled “Soft Buffer Management For Enhanced Carrier Aggregation,” filed Jan. 30, 2015, assigned to the assignee hereof.

### BACKGROUND

1. Field of Disclosure

The following relates generally to wireless communication, and more specifically to soft buffer management for enhanced carrier aggregation (eCA).

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system).

By way of example, a wireless multiple-access communications system may include a number of base stations, each simultaneously supporting communication for multiple communication devices, which may be otherwise known as user equipment (UEs). A base station may communicate with the communication devices on downlink channels (e.g., for transmissions from a base station to a UE) and uplink channels (e.g., for transmissions from a UE to a base station).

In some cases, a UE may communicate with a large number of component carriers (CCs) for carrier aggregation (CA). When receiving transmissions over the CCs, some of the transmissions may be received incorrectly, and the UE may store information related to the retransmissions (e.g., log-likelihood ratios (LLRS)) in a soft buffer to improve the likelihood of decoding subsequent versions of the incorrectly received data. If the soft buffer is partitioned among all of the CCs, a small number of bits may be available for retransmissions from any given CC. This may reduce the likelihood of correctly decoding the subsequent versions of the data, and may thus reduce the throughput of the wireless communication link.

### SUMMARY

Systems, methods, and apparatuses for soft buffer management in enhanced carrier aggregation (eCA) are described. A user equipment (UE) may determine a reference number of component carriers (CCs) for partitioning a soft buffer when the number of CCs configured for carrier aggregation (CA) operation exceeds a threshold (e.g., in eCA operation). For example, the reference number of CCs may be associated with the soft buffer size or the category of the UE. The UE may partition the soft buffer based on a comparison between the reference number of CCs and the number of the CCs (e.g., the UE may select the minimum of the reference number of CCs and the number of the configured CCs). The UE may then allocate portions of the soft buffer to different CCs based on the partition and the status of the corresponding hybrid automatic repeat request (HARQ) processes (e.g., if the UE fails to correctly receive a transmission). The UE may store a set of log-likelihood ratio (LLRs) for each HARQ process in the corresponding portions of the soft buffer.

A method of wireless communication is described. The method may include receiving signaling indicative of a plurality of CCs configured for CA operation, determining a reference number of CCs for partitioning a soft buffer when the number of CCs configured for CA operation exceeds a threshold, and partitioning the soft buffer based at least in part on a comparison between the reference number of CCs and the number of the CCs configured for CA operation.

An apparatus for wireless communication is described. The apparatus may include means for receiving signaling indicative of a plurality of CCs configured for CA operation, means for determining a reference number of CCs of CCs for partitioning a soft buffer when the number of CCs configured for CA operation exceeds a threshold, and means for partitioning the soft buffer based at least in part on a comparison between the reference number of CCs and the number of the CCs configured for CA operation.

A further apparatus for wireless communication is described. The apparatus may include a processor, memory in electronic communication with the processor, and instructions stored in the memory and operable, when executed by the processor, to cause the apparatus to receive signaling indicative of a plurality of CCs configured for CA operation, determine a reference number of CCs for partitioning a soft buffer when the number of CCs configured for CA operation exceeds a threshold, and partition the soft buffer based at least in part on a comparison between the reference number of CCs and the number of the CCs configured for CA operation.

A non-transitory computer-readable medium storing code for wireless communication is described. The code may include instructions executable to receive signaling indicative of a plurality of CCs configured for CA operation, determine a reference number of CCs for partitioning a soft buffer when the number of CCs configured for CA operation exceeds a threshold, and partition the soft buffer based at least in part on a comparison between the reference number of CCs and the number of the CCs configured for CA operation.

In some examples of the method, apparatuses, or non-transitory computer-readable medium described herein, the partitioning is based at least in part on a minimum of the reference number of CCs and the number of the configured CCs. Additionally, in some examples, determining the reference number of CCs is based at least in part on a UE category.

Some examples of the method, apparatuses, or non-transitory computer-readable medium described herein may further include processes, features, means, or instructions for transmitting an indication of the UE category to a base station, and receiving the reference number of CCs from the base station. Additionally or alternatively, in some examples, determining the reference number of CCs is based at least in part on the number of the CCs.

In some examples of the method, apparatuses, or non-transitory computer-readable medium described herein, the reference number of CCs is based at least in part on a size of the soft buffer. Additionally or alternatively, in some examples, the size of the soft buffer is associated with a UE category, and the reference number of CCs is less than a maximum number of CCs supported by the UE category.

Some examples of the method, apparatuses, or non-transitory computer-readable medium described herein may further include processes, features, means, or instructions for allocating a portion of the soft buffer to a CC from the plurality of CCs based at least in part on the partitioning and a termination status of a HARQ process, and storing a set of LLRs for the HARQ process in the portion of the soft buffer. Additionally or alternatively, in some examples, partitioning the soft buffer comprises identifying at least one of a number of code blocks, a soft buffer size for a code block at a base station, a number of HARQ processes, a HARQ process limit, or any combination thereof.

In some examples of the method, apparatuses, or non-transitory computer-readable medium described herein, determining the threshold is five CCs. Additionally or alternatively, some examples may include processes, features, means, or instructions for determining a correspondence between the partitioning of the soft buffer and a plurality of scheduled CCs based at least in part on a prioritization of the plurality of CCs.

In some examples of the method, apparatuses, or non-transitory computer-readable medium described herein, the plurality of CCs are grouped into at least a primary group and a secondary group, wherein each group comprises at least one CC from the plurality of CCs. Additionally or alternatively, in some examples, the primary group and the secondary group are part of a dual-connectivity operation.

A method of wireless communication is described. The method may include receiving signaling indicative of a plurality of CCs configured for CA operation, wherein the plurality of CCs comprises two or more priority groups, identifying a weighting factor for each priority group and a reference number of CCs for each priority group, calculating a number of soft buffer partitions based at least in part on the weighting factor and a number of CCs for each priority group, and partitioning a soft buffer based at least in part on the number of soft buffer partitions.

An apparatus for wireless communication is described. The apparatus may include means for receiving signaling indicative of a plurality of CCs configured for CA operation, wherein the plurality of CCs comprises two or more priority groups, means for identifying a weighting factor for each priority group and a reference number of CCs for each priority group, means for calculating a number of soft buffer partitions based at least in part on the weighting factor and a number of CCs for each priority group, and means for partitioning a soft buffer based at least in part on the number of soft buffer partitions.

A further apparatus for wireless communication is described. The apparatus may include a processor, memory in electronic communication with the processor, and instructions stored in the memory and operable, when executed by the processor, to cause the apparatus to receive signaling indicative of a plurality of CCs configured for CA operation, wherein the plurality of CCs comprises two or more priority groups, identify a weighting factor for each priority group and a reference number of CCs for each priority group, calculate a number of soft buffer partitions based at least in part on the weighting factor and a number of CCs for each priority group, and partition a soft buffer based at least in part on the number of soft buffer partitions.

A non-transitory computer-readable medium storing code for wireless communication is described. The code may include instructions executable to receive signaling indicative of a plurality of CCs configured for CA operation, wherein the plurality of CCs comprises two or more priority groups, identify a weighting factor for each priority group and a reference number of CCs for each priority group, calculate a number of soft buffer partitions based at least in part on the weighting factor and the reference number of CCs for each priority group, and partition a soft buffer based at least in part on the number of soft buffer partitions.

The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates an exemplary wireless communications system that supports soft buffer management for eCA in accordance with various aspects of the present disclosure;

FIG. 2 illustrates an exemplary wireless communications system that supports soft buffer management for eCA in accordance with various aspects of the present disclosure;

FIG. 3 illustrates an exemplary soft buffer that supports soft buffer management for eCA in accordance with various aspects of the present disclosure;

FIG. 4 illustrates an exemplary process flow in a system that supports soft buffer management for eCA in accordance with various aspects of the present disclosure;

FIG. 5 shows a block diagram of an exemplary wireless device that supports soft buffer management for eCA in accordance with various aspects of the present disclosure;

FIG. 6 shows a block diagram of an exemplary wireless device that supports soft buffer management for eCA in accordance with various aspects of the present disclosure;

FIG. 7 shows a block diagram of an exemplary wireless device that supports soft buffer management for eCA in accordance with various aspects of the present disclosure;

FIG. 8 illustrates an exemplary system including, a user equipment (UE), that supports soft buffer management for eCA in accordance with various aspects of the present disclosure;

FIG. 9 illustrates a method for soft buffer management in eCA in accordance with various aspects of the present disclosure;

FIG. 10 illustrates a method for soft buffer management in eCA in accordance with various aspects of the present disclosure;

FIG. 11 illustrates a method for soft buffer management in eCA in accordance with various aspects of the present disclosure;

FIG. 12 illustrates a method for soft buffer management in eCA in accordance with various aspects of the present disclosure;

FIG. 13 illustrates a method for soft buffer management in eCA in accordance with various aspects of the present disclosure; and

FIG. 14 illustrates a method for soft buffer management in eCA in accordance with various aspects of the present disclosure.

### DETAILED DESCRIPTION

A UE may determine a reference number of CCs for partitioning a soft buffer when the number of the CCs configured for CA operation exceeds a threshold. For example, the reference number of CCs may be associated with the soft buffer size or the category of the UE. The UE may partition the soft buffer based on a comparison between the reference number of CCs and the number of the CCs. The UE may then allocate portions of the soft buffer to different CCs based on the partition and the status of the corresponding HARQ processes (e.g., if the UE fails to correctly receive a transmission). The UE may store a set of log-likelihood ratios (LLRs) for each HARQ process in the corresponding portions of the soft buffer.

Some wireless communication systems may be configured to operate using a number of CCs simultaneously in carrier aggregation (CA). In some cases, CA may be supported by a UE for up to five CCs. Each CC may be up to 20 MHz, and may be backwards compatible with systems which do not operate using CA. As such, up to 100 MHz may be allocated for each UE. In other systems, more than five CCs may be configured simultaneously, and more than 100 MHz of bandwidth may be used, in an eCA. CCs configured for CA may all use frequency division duplexing (FDD), time division duplexing (TDD), or a combination thereof. Component carriers using TDD may have the same, or similar, downlink (DL) or uplink (UL) configurations, or different DL/UL configurations. Further, some subframes, e.g., special subframes, may use different DL/UL configurations.

If a number of configured CCs for CA is more than a threshold (e.g., more than five CCs), the configuration may be known as eCA operation. UEs that support uplink carrier aggregation and pSCells may benefit from enhancements to DL and UL control signaling for eCA configurations (e.g., 6-32 CC configurations). By way of example, DL control signaling may include self-scheduling and cross-carrier scheduling if present. UL control signaling may include support for uplink control information (UCI) feedback on PUCCH for up to 32 DL carriers, or support for UCI feedback on physical uplink shared channels (PUSCH) for up to 32 DL carriers.

UEs of different categories may have different capabilities. In some cases, UE category information may be used by a base station to ensure that base stations and UEs communicate effectively. For example, with knowledge of the category of the UE, a base station may use defined UL capabilities when communicating with the UE by ensuring that communication techniques or resources utilized by the base station are compatible with the UE. Various categories of UE may accommodate different numbers of CC configurations. For example, certain categories of UE may support up to 16 CC, while another category may support up to 32 CCs. Still other categories of UE may support fewer or more CCs. Table 1 illustrates example UE categories and a number of soft channel bits associated with each.

TABLE 1
Number of Soft Channel Bits by UE Category

| | Maximum number | Maximum number | Total | Maximum number |
|---|---|---|---|---|
| | of DL-SCH | of bits of a DL- | number | of supported |
| | transport block | SCH transport | of soft | layers for |
| UE | bits received | block received | channel | spatial multi- |
| Category | within a TTI | within a TTI | bits | plexing in DL |
| Category 1 | 10296 | 10296 | 250368 | 1 |
| Category 2 | 51024 | 51024 | 1237248 | 2 |
| Category 3 | 102048 | 75376 | 1237248 | 2 |
| Category 4 | 150752 | 75376 | 1827072 | 2 |
| Category 5 | 299552 | 149776 | 3667200 | 4 |
| Category 6 | 301504 | 149776 (4 layers) | 3654144 | 2 or 4 |
| | | 75376 (2 layers) | | |
| Category 7 | 301504 | 149776 (4 layers) | 3654144 | 2 or 4 |
| | | 75376 (2 layers) | | |
| Category 8 | 2998560 | 299856 | 35982720 | 8 |

In some cases, and as explained in further detail below, a UE may not properly receive a transmission from a base station. The UE may use a retransmission request to prompt the base station to resend the transmission, which the UE may properly receive. Error-detection and correction—e.g., a cyclic redundancy check (CRC) or forward error correction (FEC)—may be used to determine whether retransmission is necessary. A wireless system may employ various error-detection and retransmission techniques, including hybrid automatic repeat request (HARQ).

Different frame structures and carrier configurations may support different error correction schemes. In some cases, frequency-division duplex (FDD) configurations may support up to eight DL HARQ processes, for example; while for time-division duplex (TDD) configurations, the number of DL HARQ process may depend on TDD DL/UL subframe configuration and may be up to 15. Table 2 illustrates examples of maximum DL HARQ processes for various TDD UL/DL configurations.

TABLE 2
Maximum Number of DL HARQ Processor for TDD

| TDD UL/DL | Maximum number of |
|---|---|
| configuration | HARQ processes |
| 0 | 4 |
| 1 | 7 |
| 2 | 10 |
| 3 | 9 |
| 4 | 12 |
| 5 | 15 |
| 6 | 6 |

Soft combining may be used by storing incorrectly received data (e.g., data for which retransmission will be requested) to a buffer—e.g., a reconfigurable soft buffer—and combining the retransmitted data with the data stored in the buffer upon reception of the retransmitted data. A soft buffer may be partitioned among HARQ processes, codewords, and number of configured component carriers, and may be done in a semi-static manner.

A soft buffer size could be enlarged to accommodate additional CCs for a UE that is capable of communicating using, e.g., more than five CCs. For instance, if a UE is able to communicate using up to 32 CCs, it is conceivable that a soft buffer could be increased 6.4 times (i.e., 32/5) to account for the additional CCs of eCA (e.g., CCs 6-32). It may, however, be unnecessary to reserve that many resources for the soft buffer because it may be a rare scenario in which every CC will need to utilize soft buffer resources for retransmission. Accordingly, and as described herein, a soft buffer may be configured based on a number different from the number of CCs a UE may accommodate or different from the number of CCs configured for the UE.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

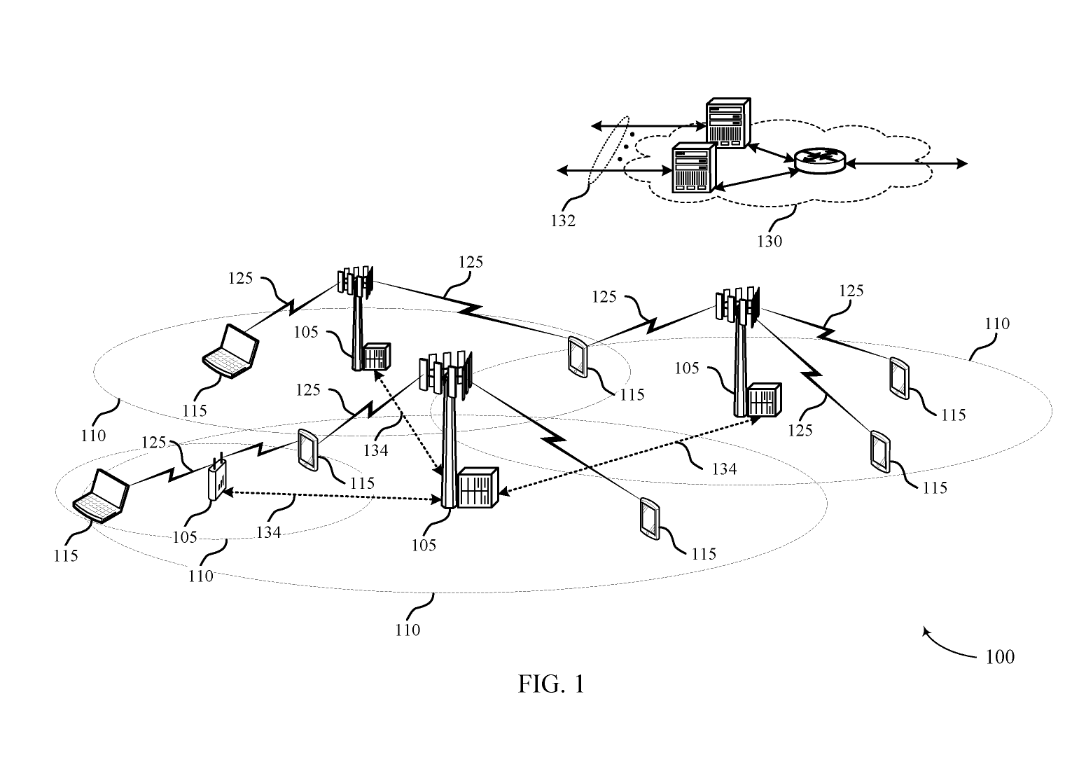

FIG. 1 illustrates an example of a wireless communications system 100 in accordance with various aspects of the present disclosure. The wireless communications system 100 includes base stations 105, UEs 115, and a core network 130, and may support eCA operation. The core network 130 may provide user authentication, access authorization, tracking, interne protocol (IP) connectivity, and other access, routing, or mobility functions. The base stations 105 interface with the core network 130 through backhaul links 132 (e.g., S1, etc.). The base stations 105 may perform radio configuration and scheduling for communication with the UEs 115, or may operate under the control of a base station controller (not shown). In various examples, the base stations 105 may communicate, either directly or indirectly (e.g., through core network 130), with one another over backhaul links 134 (e.g., X1, etc.), which may be wired or wireless communication links. Some of the base stations 105 may be connected via non-ideal backhaul links, as discussed above.

The base stations 105 may wirelessly communicate with the UEs 115 via one or more base station antennas. Each of the base stations 105 may provide communication coverage for a respective geographic coverage area 110. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up only a portion of the coverage area (not shown). The wireless communications system 100 may include base stations 105 of different types (e.g., macro or small cell base stations). There may be overlapping geographic coverage areas 110 for different technologies

In some examples, the wireless communications system 100 is a Long Term Evolution (LTE)/LTE-Advanced (LTE-A) network. In LTE/LTE-A networks, the term evolved node B (eNB) may be generally used to describe the base stations 105, while the term UE may be generally used to describe the UEs 115. The wireless communications system 100 may be a heterogeneous LTE/LTE-A network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by UEs 115 with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The wireless communications system 100 may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

The communication networks that may accommodate some of the various disclosed examples may be packet-based networks that operate according to a layered protocol stack and data in the user plane may be based on the IP. A radio link control (RLC) layer may perform packet segmentation and reassembly to communicate over logical channels. A medium access control (MAC) layer may perform priority handling and multiplexing of logical channels into transport channels. The MAC layer may also use hybrid automatic repeat request (HARQ) to provide retransmission at the MAC layer to improve link efficiency. In the control plane, the radio resource control (RRC) protocol layer may provide establishment, configuration, and maintenance of an RRC connection between a UE 115 and the base stations 105. The RRC protocol layer may also be used for core network 130 support of radio bearers for the user plane data. At the physical (PHY) layer, the transport channels may be mapped to physical channels.

As mentioned above, HARQ may be a method of ensuring that data is received correctly over a wireless communication link 125. HARQ may include a combination of error detection (e.g., using a CRC), forward error correction (FEC), and retransmission (e.g., automatic repeat request (ARQ)). HARQ may improve throughput at the MAC layer in poor radio conditions (e.g., signal-to-noise conditions). In Incremental Redundancy HARQ, incorrectly received data may be stored in a buffer and combined with subsequent transmissions to improve the overall likelihood of successfully decoding the data. In some cases, redundancy bits are added to each message prior to transmission. This may be especially useful in poor conditions. In other cases, redundancy bits are not added to each transmission, but are retransmitted after the transmitter of the original message receives a negative acknowledgement (NACK) indicating a failed attempt to decode the information.

The UEs 115 may be dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with various types of base stations and network equipment including macro eNBs, small cell eNBs, relay base stations, and the like. UEs 115 may be of various categories, as mentioned above with reference to Table 1. Some UEs 115 may be cable of eCA operation.

The communication links 125 shown in wireless communications system 100 may include uplink (UL) transmissions from a UE 115 to a base station 105, or downlink (DL) transmissions, from a base station 105 to a UE 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

Wireless communications system 100 may support operation on multiple cells or carriers, a feature which may be referred to as carrier aggregation (CA) or multi-carrier operation. A carrier may also be referred to as a CC, a layer, a channel, etc. The term “component carrier” may refer to each of the multiple carriers utilized by a UE in carrier aggregation (CA) operation, and may be distinct from other portions of system bandwidth. For instance, a component carrier may be a relatively narrow-bandwidth carrier susceptible of being utilized independently or in combination with other component carriers. Each component carrier may provide the same capabilities as an isolated carrier based on release 8 or release 9 of the LTE standard. Multiple component carriers may be aggregated or utilized concurrently to provide some UEs 115 with greater bandwidth and, e.g., higher data rates.

Thus, individual CCs may be backwards compatible with legacy UEs 115 (e.g., UEs 115 implementing LTE release 8 or release 9); while other UEs 115 (e.g., UEs 115 implementing post-release 8/9 LTE versions), may be configured with multiple component carriers in a multi-carrier mode. A carrier used for DL may be referred to as a DL CC, and a carrier used for UL may be referred to as an UL CC. A UE 115 may be configured with multiple DL CCs and one or more UL CCs for carrier aggregation. Each carrier may be used to transmit control information (e.g., reference signals, control channels, etc.), overhead information, data, etc. In some cases, the number of CCs configured for a UE 115 may be limited to 5. However, in other cases, the number may be configured up to some higher limit (e.g., 32) in what may be referred to as enhanced carrier aggregation (eCA) operation. eCA operation may include the use of additional or different control signaling between a UE 115 and a base station 105.

A UE 115 may communicate with a single base station 105 utilizing multiple carriers, and may also communicate with multiple base stations simultaneously on different carriers. Each cell of a base station 105 may include an UL component carrier (CC) and a DL CC. The coverage area 110 of each serving cell for a base station 105 may be different (e.g., CCs on different frequency bands may experience different path loss). In some examples, one carrier is designated as the primary carrier, or primary component carrier (PCC), for a UE 115, which may be served by a primary cell (PCell). Primary cells may be semi-statically configured by higher layers (e.g., radio resource control (RRC), etc.) on a per-UE basis. Certain uplink control information (UCI), e.g., acknowledgement (ACK)/negative ACK (NACK), channel quality indicator (CQI), and scheduling information transmitted on physical uplink control channel (PUCCH), are carried by the primary cell.

A UE 115 may be configured with a primary component carrier (PCC) for a UE 115 and one or several secondary component carriers (SCCs). The PCC may be the only CC that carries a physical uplink control channel (PUCCH) and a common search space for a UE 115. In some cases, however, PUCCH may be enabled on an SCC as well, which may be useful in dual-connectivity configurations or to help balance PUCCH load, or both. Secondary cells may likewise be semi-statically configured on a per-UE basis. In some cases, secondary cells may not include or be configured to transmit the same control information as the primary cell.

In some cases, base stations 105 may not be connected via ideal backhaul, and coordination between component carriers may be difficult. For example, the connection between the serving base stations 105 may not be sufficient to facilitate precise timing coordination. Non-ideal backhaul may thus refer to situations with limited backhaul capacity or non-negligible backhaul latency (e.g., tens of milliseconds). Dual-connectivity solutions may, however, address this issue. For instance, cells may be partitioned into two or more groups: a primary cell group (PCG) and one or more secondary cell groups (SCGs). Each group may have cells in CA operation. Further, each group may have a single cell carrying PUCCH, such as a primary cell (PCC) in the PCG and a secondary cell (SCC) in the SCG—this PUCCH-enabled SCC may be referred to as a pSCell. Thus, in some cases, the cells serving a UE 115 may be divided into multiple timing adjustment group (TAGs). Each TAG may be associated with a different timing offset, such that the UE 115 may synchronize UL transmissions differently for different UL carriers. In such cases, a common search space may additionally be monitored in the SCG by a UE. Additionally, in some examples, uplink control information is separately conveyed to each group using the PUCCH of each group. Semi-persistent scheduling (SPS) and scheduling requests (SR) may be supported for the SCG.

As mentioned above, a UE 115 may have a configurable buffer, such as a soft buffer, to store information relating to retransmission requests. With an increase in the number of CCs used for communication between a base station 105 and a UE 115, an increased soft buffer size may be required to accommodate the additional CCs. It may be inefficient to increase the buffer size proportional to the increase in CCs, as it may be unlikely that every CC has a first HARQ transmission failure. Therefore, a reference number of CCs may be used to configure a size of the soft buffer, a number of partitions of the soft buffer, a size of the partitions of the soft buffer, or an allocation of the partitions of the soft buffer. The reference number of CCs may be determined at a UE 115, at a base station 105, or at another network component. By limiting the number of CCs for soft buffer configuration, an adequate soft buffer may be configured for the majority of transmissions, while preserving resources, such as for another use.

Thus, a UE 115 may determine a reference number of CCs for partitioning a soft buffer when the number of the CCs configured for CA operation exceeds a threshold (e.g., a UE 115 may be configured with a threshold of 16 CCs, and up to 32 CCs may be configured in eCA operation). For example, the reference number of CCs may be associated with the soft buffer size or the category of the UE 115. The UE 115 may partition the soft buffer based on a comparison between the reference number of CCs and the number of the CCs. The UE 115 may then allocate portions of the soft buffer to different CCs based on the partition and the status of the corresponding HARQ processes (i.e., if the UE fails to correctly receive or to decode a transmission). The UE 115 may store a set of LLRs for each HARQ process in the corresponding portions of the soft buffer.

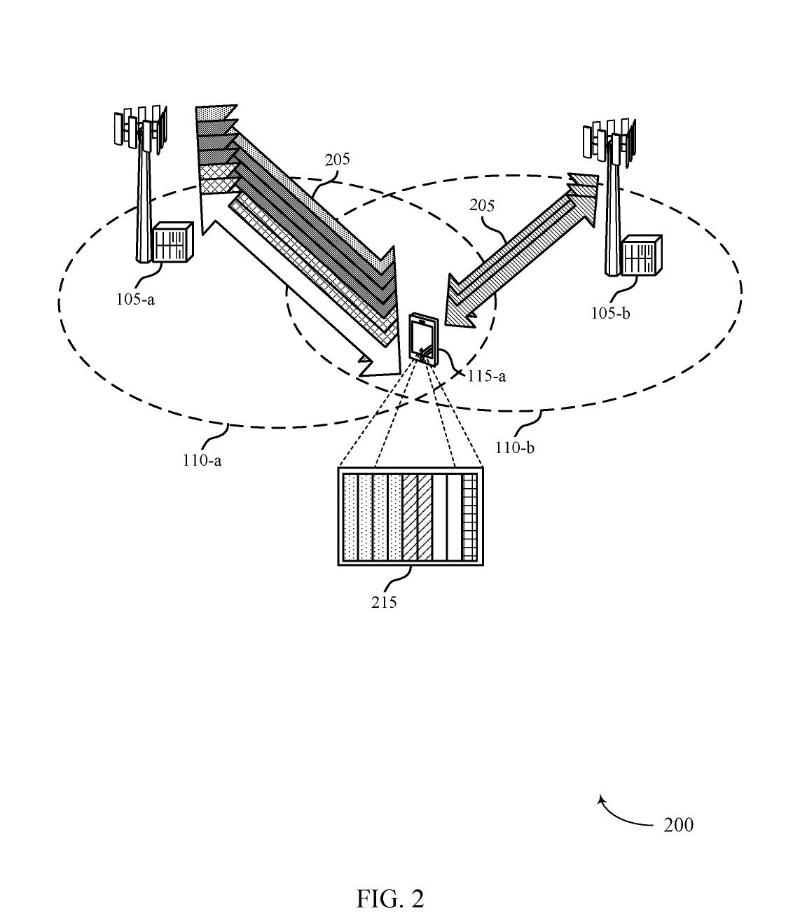

FIG. 2 illustrates an example of a wireless communications system 200 that supports joint control in eCA configurations in accordance with various aspects of the present disclosure. Wireless communications system 200 illustrates communication between base stations 105-a, 105-b and UE 115-a. In some cases, base station 105-a and UE 115-a may communicate using carrier aggregation, dual-connectivity, or some combination thereof. Base stations 105-a and 105-b may communicate with UE 115-a using communication links via CCs 205 which may be an example of communication links 125 of FIG. 1. In some cases, the CCs 205 may be grouped for purposes of scheduling or prioritization of retransmission. If a transmission from one of the configured CCs 205 is received incorrectly, base station 105-a may initiate a retransmission, such as if information is not received, incorrectly received, or if channel quality is too poor. For example, base station 105-a may use an automatic repeat request (ARQ), a hybrid automatic repeat request (HARQ), or another retransmission mechanism to initiate retransmission. UE 115-a may then store data from the original transmission in a soft buffer 215 to increase the likelihood of decoding subsequent versions of the missed transmissions.

In some cases, it may not be necessary to buffer data for all of the symbols or packets received on each CC, as it may be infrequent that a UE fails to decode a transmission. Thus, the soft buffer may be partitioned and bits of the buffer may be allocated as necessary for HARQ processes on different CCs. The soft buffer 215 may be configured in quasi-real-time, semi-statically, periodically, or statically. Aspects of the soft buffer 215 partition may be configured by UE 115-a or by base station 105-a. The communication link 125-a may be used to transmit information from base station 105-a to UE 115-a which may configure, or initiate configuration, of the soft buffer 215. For example, the number of configured cells may be used to partition the soft buffer 215. By configuring the soft buffer 215, the number of partitions or the size of partitions may be adjusted. To increase the likelihood that each partition is of sufficient size to enable UE 115-a to successfully decode retransmissions, the number of partitions may be based on a reference number of CCs instead of the number of configured CCs.

That is, increasing the number of CCs 205 may necessitate a larger soft buffer 215 or different methods of partitioning the soft buffer 215. A limit on the number of CCs may therefore be used to determine the partition may be used. The reference number of CCs may be associated with the soft buffer size or the category of UE 115-a. UE 115-a may partition the soft buffer 215 based on a comparison between the reference number of CCs and the number of the CCs. UE 115-a may then allocate portions of the soft buffer 215 to different CCs based on the partition and the status of the corresponding HARQ processes. UE 115-a may store a set of LLRs related to the failed transmissions in the allocated portions of the soft buffer 215. In the event that there are more failed transmissions on different CCs than there are soft buffer partitions, one or more sets of LLRs may be dropped based on a CC prioritization scheme.

In some cases, instead of using a reference number of CCs, a number may be calculated based on prioritization of groups of the CCs 205. Each group may be weighted with a scalar, multiplied by the number of CCs in the group, and the resulting product for each group may be summed. The resulting sum may be used as the total number of partitions in the soft buffer 215. For example, a first group of cells may be given a weighting of one and allocated with X₁ soft buffer partitions, while a second group of cells may be given a weight of ½ or ¼ and allocated X₂/2 or X₂/4 soft buffer partitions.

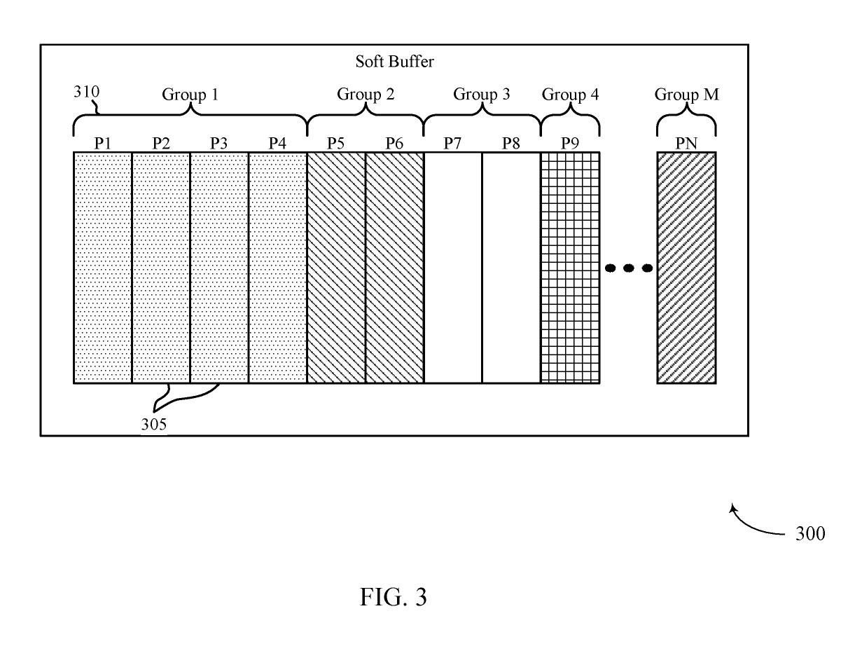

FIG. 3 illustrates an example of a soft buffer 300 for soft buffer management in eCA in accordance with various aspects of the present disclosure. The soft buffer 300 may be an example of a soft buffer 215 and may be a part of a UE 115, as described in FIG. 2. The soft buffer 300 may include a number of partitions 305. As illustrated, the soft buffer 300 includes N partitions 305. The size of the partitions 305 may depend on the number of partitions 305, and may be predefined, signaled, configured semi-statically, or configured in quasi-real-time. In some cases, the partitions 305 are all the same size, though partitions 305 may also vary in size. The total number of partitions 305 may be determined based on communicated parameters such as a UE category, and may be defined or limited by the memory resources of the UE 115. In some cases, the soft buffer 300 may be adjustable in total size, number of partitions 305, or size of partitions 305. In some cases, memory not used by the soft buffer 300 may be configured for other uses by the UE 115.

The soft buffer 300 may be configured for HARQ with soft combining. In a scheme employing HARQ with soft combining, a receiver, such as a UE 115, may receive a data block with some error and store LLRs related to the block in a buffer (e.g., soft buffer 300). After retransmission of the data block (e.g., after transmission of one or more redundancy versions), the receiver may combine the new version with existing LLRs based on one or more previous versions to increase the likelihood of successfully decoding the data. In CA operation with a relatively small number of configured CCs, a UE 115 may store soft channel bits in soft buffer 300 that is partitioned based on providing a number of soft buffer bits, n_{SB} in each partition, where:

$${n}_{SB} = min ( {N}_{cb} , ⌊ \frac{{N}_{soft}^{′}}{C \cdot {N}_{cells}^{DL} \cdot {K}_{MIMO} \cdot min ( {M}_{DL\_HARQ} , {M}_{limit} )} ⌋ ) , \qquad ( 1 )$$

N′_{soft} is the total number of soft buffer bits according to the category of the UE 115, K_{MIMO} is an integer value based on a transmission mode of the UE 115, M_{DL}_{_}_{HARQ} is the maximum number of downlink HARQ processes, Mₗᵢₘᵢₜ is a HARQ process limit (e.g., a limit of 8), C is the number of code blocks, N_{cells}^{DL} is the number of configured serving cells (e.g., CCs), and N_{cb} is the number of bits for an r-th code block.

$${N}_{cb} = min ( ⌊ \frac{{N}_{IR}}{C} ⌋ , {K}_{w} )$$

for downlink shared (DL-SCH) and paging (PCH) transport channels; N_{cb}=K_{w} for uplink shared (UL-SCH) and multicast (MCH) transport channels. K_{w} is a circular buffer length. N_{IR} denotes the soft buffer size for the r-th code block, and

$${N}_{IR} = ⌊ \frac{{N}_{soft}}{{K}_{C} \cdot {K}_{MIMO} \cdot min ( {M}_{DL\_HARQ} , {M}_{limit} )} ⌋ , \qquad ( 2 )$$

where if a UE 115 signals ue-Category-v10xy, and is configured with transmission mode 9/10 for the DL cell, N_{soft} may be the total number of soft channel bits according to the UE category indicated by ue-Category-v10xy. Otherwise, N_{soft} may be the total number of soft channel bits according to the category of the UE 115 indicated by ue-Category. For instance, if N_{soft}=35982720, K_{C} is 5 when CA is configured, or 1 or 2, depending on the capability of UE 115 (e.g., the number of layers the UE 115 can support). In some cases, K_{MIMO} is equal to 2 if the UE is configured to receive physical downlink shared channel (PDSCH) transmissions based on transmission modes 3, 4, 8, 9, or 10, such as on the given CC, and may be equal to 1 otherwise. If the UE is configured with more than one serving cell and if at least two serving cells have different UL/DL configurations, M_{DL}_{_}_{HARQ} may be the maximum number of DL HARQ processes for the DL reference UL/DL configuration of the serving cell. Otherwise, M_{DL}_{_}_{HARQ} may be the maximum number of DL HARQ processes.

As illustrated by Equations 1 and 2, soft buffer management (e.g., soft buffer size) may be described as a function of the number of HARQ process or the number of configured CCs, or both. A soft buffer may include effectively equal partitions for each CC, or may be allocated in different amounts to different CCs.

The number of partitions 305 may be limited or defined by a UE 115 or by a base station 105 when a certain number of CCs are configured (e.g., more than five). For example, the base station 105 may transmit signals to the UE 115 which may indicate, or be used to determine, a number of partitions 305 for the soft buffer 300. The UE 115 may determine the number of partitions 305, based on a received indication, other received information, or other factors or characteristics of the UE 115. For example, a number of cells configured for communication between a base station 105 and a UE 115 may be used to determine the number of partitions 305 to configure, such as by transmitting an indicator of the number of cells configured for communication from the base station 105 to the UE 115.

A value other than the number of configured CCs configured for communication may be used to determine how to partition the soft buffer 300. For example, a reference number of CCs may be used in place of, or in addition to, the actual number of CCs configured for communication. For example, the minimum of the reference number of CCs and the number of cells configured for communication may be used when determining how to partition the soft buffer 300. The reference number of CCs may be predefined, determined (e.g., by the UE 115 or by the base station 105), or signaled (e.g., from the base station 105 to the UE 115). The reference number of CCs may be a fixed value regardless of the number of configured CCs, or may have two or more values, such as corresponding to different assumptions of the number of configured CCs, or corresponding to different UE categories.

At times, the reference number of CCs may be determined based on a probability that all, or more than all, of the partitions 305 would be needed, such as for retransmission requests. For example, a limit of ten CCs may satisfy the need for many eCA scenarios up to 32 component carriers, without unnecessarily allocating resources to the soft buffer 300 which may be rarely used, or better used for another purpose. Assuming, for instance, that 32 CCs are configured for a UE, and assuming a 10% block error rate (BLER) for the first HARQ transmission, the probability of having more than the reference number of CCs of CCs with first HARQ transmission failure may be roughly 0.33% with a limit of 8, the probability may be 0.017% with a limit of 10; or it the probability may be 0.006% with a limit of 12. It should be noted, however, that the reference number of CCs, as described here may be a limit for determining the size or partitions 305 of the soft buffer 300, rather than a limit on the number of CCs a UE 115 may use of be configured with.

By way of example, N_{Limit}^{DL} may represent the reference number of CCs, such that:

$${n}_{SB} = min ( {N}_{cb} , ⌊ \frac{{N}_{soft}^{′}}{C \cdot min ( {N}_{Limit}^{DL} , {N}_{cells}^{DL} ) \cdot {K}_{MIMO} \cdot min ( {M}_{DL\_HARQ} , {M}_{limit} )} ⌋ ) , \qquad ( 3 )$$

where the equation may be tied with, or implemented based on a UE category, and the UE category's soft buffer size may be defined based on K carriers, although the UE 115 may support up to 32 CCs. In some cases, Mₗᵢₘᵢₜ may thus be used to limit the number of HARQ processes for soft buffer size partitioning and N_{Limit}^{DL} it may be used to limit the number of CCs for soft buffer size partitioning. In some examples, if the actual scheduled number of CCs exceeds the reference number of CCs, the UE 115 may determine how to store the corresponding LLRs. Additionally or alternatively, in some cases, PCells or pSCells may be given higher priority for partitioning; or a higher priority may be assigned to for a larger transport block size (TBS) or higher MCS or a HARQ process on a CC with the latest transmission.

In some cases, the reference number of CCs may be less than the number of CCs configured for a UE. Then, the UE may dynamically allocate the soft buffer 300 to different CCs based on HARQ termination status for each CC. Further, different CCs may have a different number of DL HARQ process, but the limit Mₗᵢₘᵢₜ=8 may enforce a value of 8 used to partition the per-CC soft buffer into different HARQ processes. As a result, unless M_{DL}_{_}_{HARQ}<8 for a CC, all CCs may substantially have the same per HARQ process soft buffer size.

In some cases, subsets of the partitions 305 of the soft buffer 300 may be grouped together to form groups 310 of partitions 305. The groups 310 may include the same number of partitions 305 or different numbers of partitions 305. Further, partitions within a group 310 may be the same size or different sizes, and partitions 305 across groups 310 may be the same size, or of different sizes. The groups 310 may be prioritized. For example, group 1 may be higher priority compared to group 2, and therefore group 1 may be allocated more soft buffer 300 partitions 305 than group 2. The size of groups 310 may be determined at the UE 115, or at the base station 105 and subsequently signaled to the UE 115. Parameters may be signaled or determined, such as a default number of partitions 305 or group scalar values. For example, a default number of partitions 305 per group 310 may be eight. Groups 1 through M may have a scalar value associated with them based on the default number of partitions. For example, group 1 may have a scalar value of one half, while groups 2 and 3 may have scalar values of one quarter, and groups 4 and M may have scalar values of one eighth. At times, a limit of the number of HARQ processes may be based on the scalar values for each group. By grouping the soft buffer partitions, reuse of the soft buffer 300 across CCs may be reduced. Further, for a CC which has a scalar value less than one, a reduction of Mₗᵢₘᵢₜ may be considered, such that per HARQ process soft buffer size for the CC is not too small.

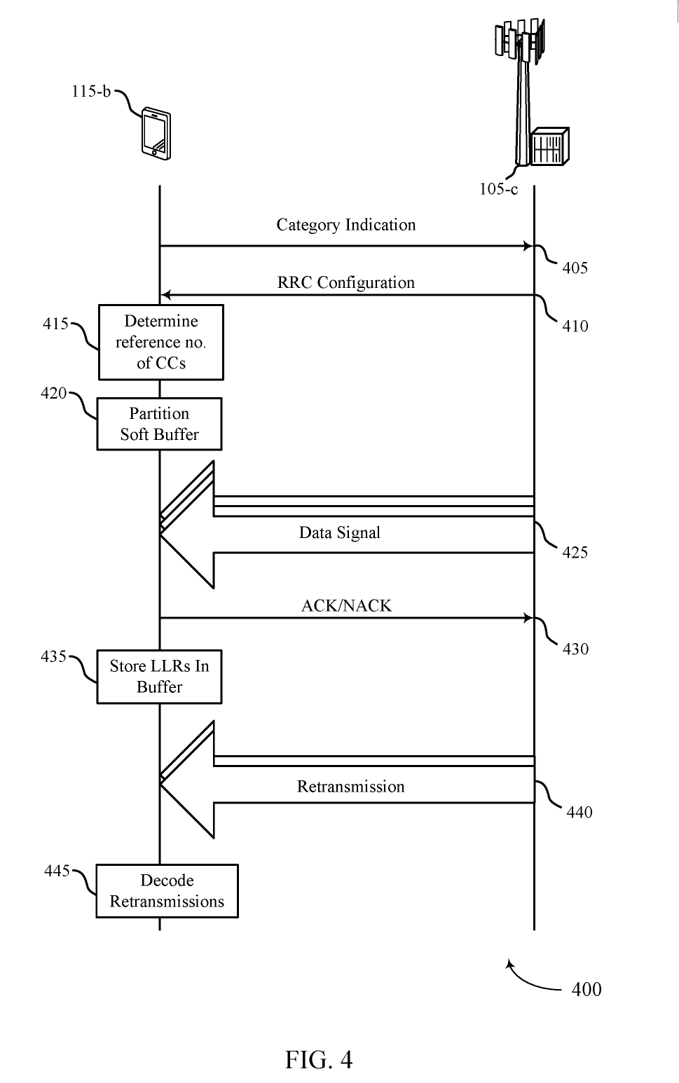

FIG. 4 illustrates an example of a Process flow 400 for soft buffer management in eCA in accordance with various aspects of the present disclosure. Process flow 400 may represent a communication process between UE 115-b and base station 105-c, which may be examples of a UE 115 and a base station 105 described herein with reference to FIGS. 1-2.

At block 405, UE 115-b may transmit an indication of its UE category to base station 105-b. In some cases, the category may be used to determine a number of soft buffer partitions for UE 115-b.

At block 410, base station 105-c may transmit (and UE 115-b may receive) receive signaling indicative of a plurality of CCs configured for CA operation (or dual-connectivity operation). In some cases, UE 115-b may determine a correspondence between the partitioning of the soft buffer and a plurality of scheduled CCs based on a prioritization of the plurality of CCs. In some examples, the plurality of CCs are grouped into at least a primary group and a secondary group, where each group includes at least one CC from the plurality of CCs. In some examples, the primary group and the secondary group are part of a dual-connectivity operation. In some cases, the signaling may be RRC layer signaling.

At block 415, UE 115-b or base station 105-c may determine a reference number of CCs to be used in determining a partition for the soft buffer. If base station 105-c determines the limit for the number of component carriers, base station 105-c may signal the reference number of CCs to UE 115-b. It should be noted that the reference number of CCs may correspond to the number of component carriers for soft buffer purposes rather than a limit on the number of configured or scheduled component carriers base station 105-c and UE 115-b are able to use for communication. In some examples, the reference number of CCs is based on a size of the soft buffer. In some examples, the size of the soft buffer is associated with a UE category, and the reference number of CCs is less than a maximum number of CCs supported by the UE category.

At block 420, UE 115-b may partition the soft buffer based on a comparison between the reference number of CCs and the number of the CCs configured for CA operation. In some examples the partitioning is based on a minimum of the reference number of CCs and the number of the configured CCs. In some examples determining the reference number of CCs is based on a UE category. In some examples, partitioning the soft buffer includes: identifying at least one of a number of code blocks, a soft buffer size for a code block at a base station, a number of HARQ processes, a HARQ process limit, or any combination thereof.

At block 425, base station 105-c may communicate with UE 115-b using a number of CCs. The communication may be based on a number of HARQ processes. In some cases, the number of CCs is greater than 5.

At block 430, UE 115-b may transmit HARQ feedback for each of the HARQ processes. In some cases, some transmissions may be received incorrectly, and UE 115-b may transmit a NACK for each transmission received in error.

At block 435, UE 115-b may store information related to retransmission requests (e.g., LLRs corresponding to each NACK) in a soft buffer. That is, UE 115-b may allocate a portion of the soft buffer to a CC based on the partitioning and a termination status of a HARQ process. Then UE 115-b may store a set of log-likelihood ratio (LLRs) for the HARQ process in the portion of the soft buffer.

At block 440, base station 105-c may retransmit a number of data blocks (e.g., using additional redundancy versions) to UE 115-b based on the received HARQ feedback. The number of retransmissions may be less than the original number of transmissions.

At block 445, UE 115-b may decode the retransmissions using the information in the soft buffer.

As an alternative to using a reference number of CCs, UE 115-b may group the configured CCs into two or more priority groups, identify a weighting factor for each priority group and a reference number of CCs for each priority group, and calculate a number of soft buffer partitions based on the weighting factor and a number of CCs for each priority group. UE 115-b may then partition the soft buffer based on the number of soft buffer partitions determined in this manner.

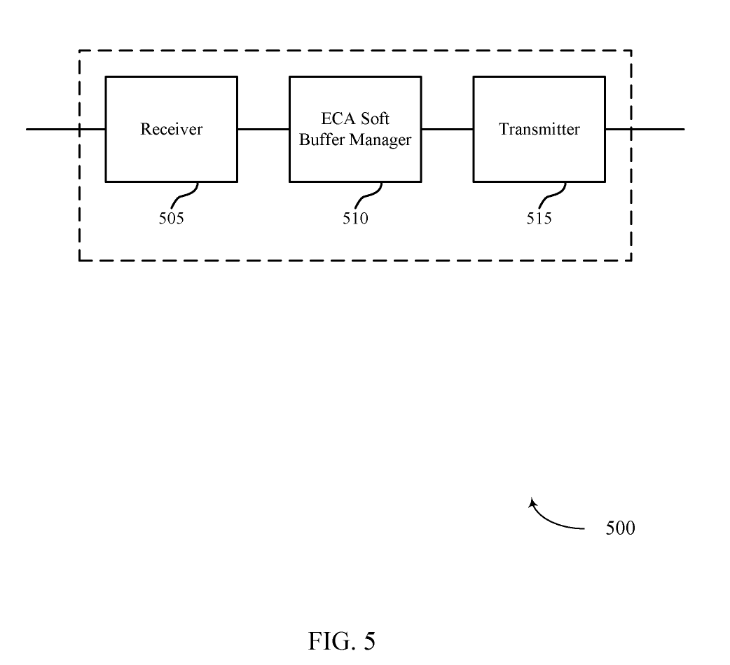

FIG. 5 shows a block diagram of a wireless device 500 configured for soft buffer management in eCA in accordance with various aspects of the present disclosure. Wireless device 500 may be an example of aspects of a UE 115 described with reference to FIGS. 1-4. Wireless device 500 may include a receiver 505, an eCA soft buffer manager 510, or a transmitter 515. Wireless device 500 may also include a processor. Each of these components may be in communication with one another.

The receiver 505 may receive information such as packets, user data, or control information associated with various information channels (e.g., control channels, data channels, and information related to soft buffer management for eCA, etc.). Information may be passed on to the eCA soft buffer manager 510, and to other components of wireless device 500. In some examples, the receiver 505 may receive a reference number of CCs from a base station.

The eCA soft buffer manager 510 may receive signaling indicative of a plurality of CCs configured for CA operation, determine a reference number of CCs for partitioning a soft buffer when a number of the CCs configured for CA operation exceeds a threshold, and partition the soft buffer based on a comparison between the reference number of CCs and the number of the CCs configured for CA operation.

The transmitter 515 may transmit signals received from other components of wireless device 500. In some examples, the transmitter 515 may be collocated with the receiver 505 in a transceiver module. The transmitter 515 may include a single antenna, or it may include a plurality of antennas.

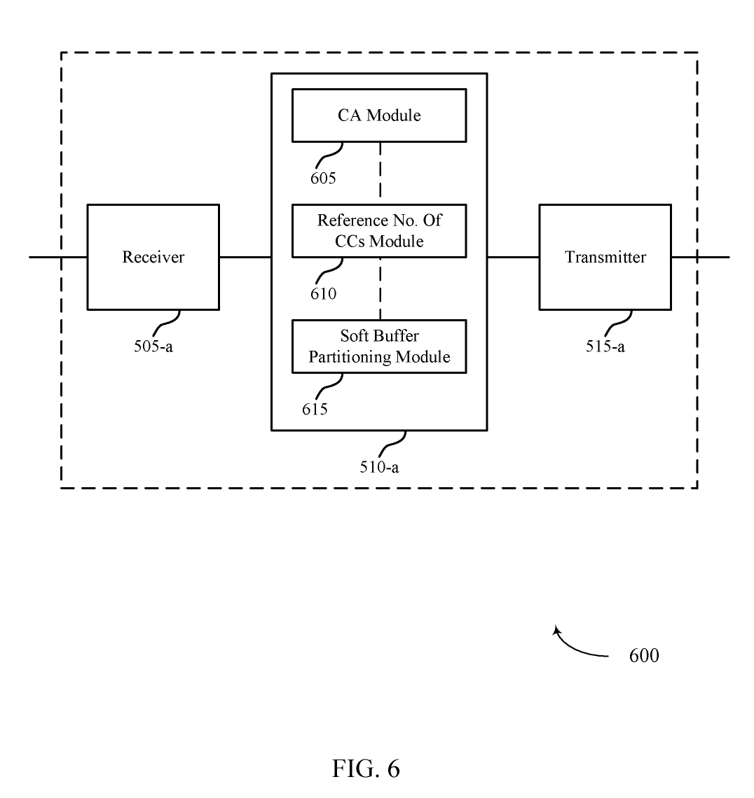

FIG. 6 shows a block diagram of a wireless device 600 for soft buffer management in eCA in accordance with various aspects of the present disclosure. Wireless device 600 may be an example of aspects of a wireless device 500 or a UE 115 described with reference to FIGS. 1-5. Wireless device 600 may include a receiver 505-a, an eCA soft buffer manager 510-a, or a transmitter 515-a. Wireless device 600 may also include a processor. Each of these components may be in communication with each other. The eCA soft buffer manager 510-a may also include a CA module 605, a reference number of CCs module 610, and a soft buffer partitioning module 615.

The receiver 505-a may receive information which may be passed on to eCA soft buffer manager 510-a, and to other components of wireless device 600. The eCA soft buffer manager 510-a may perform the operations described herein with reference to FIG. 5. The transmitter 515-a may transmit signals received from other components of wireless device 600.

The CA module 605 may receive signaling indicative of a plurality of CCs configured for CA operation as described herein with reference to FIGS. 2-4. The CA module 605 may also receive signaling indicative of a plurality of CCs configured for CA operation, and the plurality of CCs may include two or more priority groups.

The reference number of CCs module 610 may determine a reference number of CCs for partitioning a soft buffer when a number of the CCs configured for CA operation exceeds a threshold as described herein with reference to FIGS. 2-4. In some examples, determining the reference number of CCs may be based on a UE category. In some cases, determining the reference number of CCs may be based on the number of the CCs. Additionally or alternatively, the reference number of CCs may be based on a size of the soft buffer. The number of configured CCs may, for example, be more than five.

The soft buffer partitioning module 615 may partition the soft buffer based on a comparison between the reference number of CCs and the number of the CCs configured for CA operation as described herein with reference to FIGS. 2-4. In some examples, the partitioning may be based on a minimum of the reference number of CCs and the number of the configured CCs. In some cases, partitioning the soft buffer includes identifying at least one of a number of code blocks, a soft buffer size for a code block at a base station, a number of HARQ processes, a HARQ process limit. The soft buffer partitioning module 615 may also calculate a number of soft buffer partitions based on the weighting factor and a number of CCs for each priority group. The soft buffer partitioning module 615 may, in some examples, partition a soft buffer according to the number of soft buffer partitions calculated based on the weight associated with different CC groups.

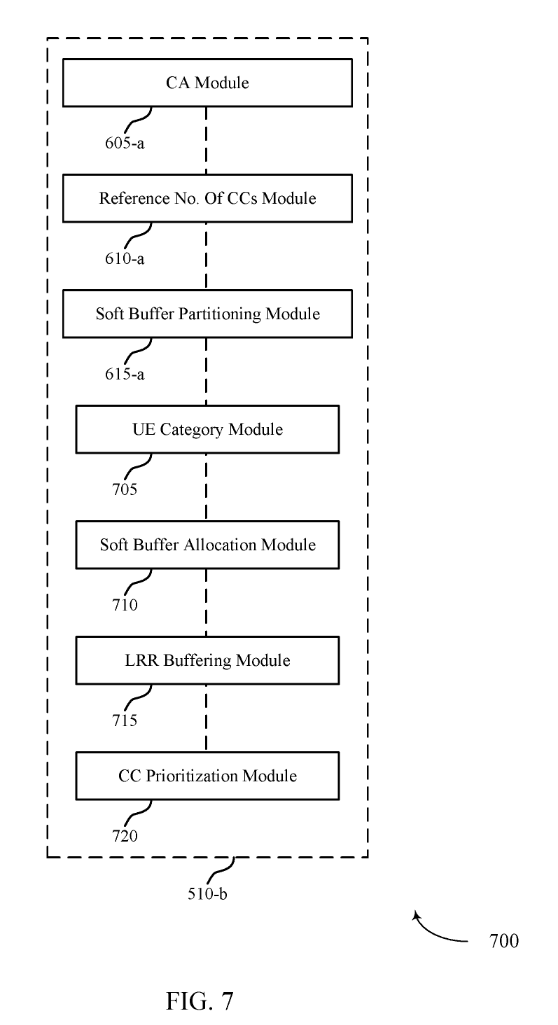

FIG. 7 shows a block diagram 700 of an eCA soft buffer manager 510-b which may be a component of a wireless device 500 or a wireless device 600 for soft buffer management in eCA in accordance with various aspects of the present disclosure. The eCA soft buffer manager 510-b may be an example of aspects of an eCA soft buffer manager 510 described with reference to FIGS. 5-6. The eCA soft buffer manager 510-b may include a CA module 605-a, a reference number of CCs module 610-a, and a soft buffer partitioning module 615-a. Each of these modules may perform the functions described herein with reference to FIG. 6. The eCA soft buffer manager 510-b may also include a UE category module 705, a soft buffer allocation module 710, an LLR buffering module 715, and a CC prioritization module 720.

The UE category module 705 may transmit an indication of the UE category to a base station as described herein with reference to FIGS. 2-4. In some examples, the size of the soft buffer may be associated with a UE category, and the size may be determined based on the reference number of CCs, which may be less than a maximum number of CCs supported by the UE category.

The soft buffer allocation module 710 may allocate a portion of the soft buffer to a CC from the plurality of CCs based on the partitioning and a termination status of a HARQ process as described herein with reference to FIGS. 2-4.

The LLR buffering module 715 may store a set of LLRs for one or more HARQ processes in the corresponding portion of the soft buffer as described herein with reference to FIGS. 2-4.

The CC prioritization module 720 may determine a correspondence between the partitioning of the soft buffer and a plurality of scheduled CCs based on a prioritization of the plurality of CCs as described herein with reference to FIGS. 2-4. In some examples, the plurality of CCs are grouped into at least a primary group and a secondary group, where each group includes at least one CC from the plurality of CCs. In some examples, the primary group and the secondary group are part of a dual-connectivity operation. The CC prioritization module 720 may also identify a weighting factor for each priority group and a reference number of CCs for each priority group.

The components of wireless device 500, wireless device 600, and eCA soft buffer manager 510-b may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

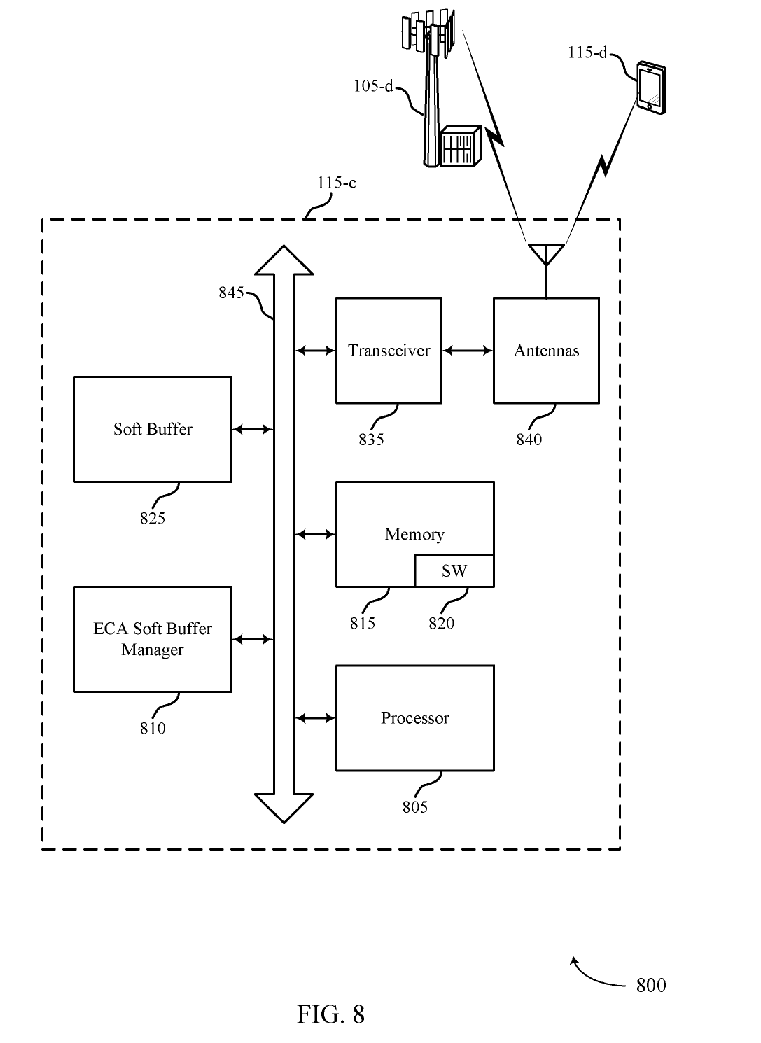

FIG. 8 shows a diagram of a system 800 including a UE 115 configured for soft buffer management in eCA in accordance with various aspects of the present disclosure. System 800 may include UE 115-c, which may be an example of a wireless device 500, a wireless device 600, or a UE 115 described herein with reference to FIGS. 1, 2 and 5-7. UE 115-c may include an eCA soft buffer manager 810, which may be an example of an eCA soft buffer manager 510 described with reference to FIGS. 5-7. UE 115-c may also include a soft buffer 825. UE 115-c may also include components for bi-directional voice and data communications including components for transmitting communications and components for receiving communications. For example, UE 115-c may communicate bi-directionally with base station 105-d or UE 115-d.

Soft buffer 825 may be used to store information related to HARQ transmissions to increase the likelihood of successfully receive retransmissions. Soft buffer 825 may be an example of a soft buffer 215 or a soft buffer 300 as described herein with reference to FIGS. 1-7.

UE 115-c may also include a processor 805, and memory 815 (including software (SW)) 820, a transceiver 835, and one or more antenna(s) 840, each of which may communicate, directly or indirectly, with one another (e.g., via buses 845). The transceiver 835 may communicate bi-directionally, via the antenna(s) 840 or wired or wireless links, with one or more networks, as described above. For example, the transceiver 835 may communicate bi-directionally with a base station 105 or another UE 115. The transceiver 835 may include a modem to modulate the packets and provide the modulated packets to the antenna(s) 840 for transmission, and to demodulate packets received from the antenna(s) 840. While UE 115-c may include a single antenna 840, UE 115-c may also have multiple antennas 840 capable of concurrently transmitting or receiving multiple wireless transmissions.

The memory 815 may include random access memory (RAM) and read only memory (ROM). The memory 815 may store computer-readable, computer-executable software/firmware code 820 including instructions that, when executed, cause the processor 805 to perform various functions described herein (e.g., soft buffer management for eCA, etc.). Alternatively, the software/firmware code 820 may not be directly executable by the processor 805 but cause a computer (e.g., when compiled and executed) to perform functions described herein. The processor 805 may include an intelligent hardware device, (e.g., a central processing unit (CPU), a microcontroller, an ASIC, etc.)

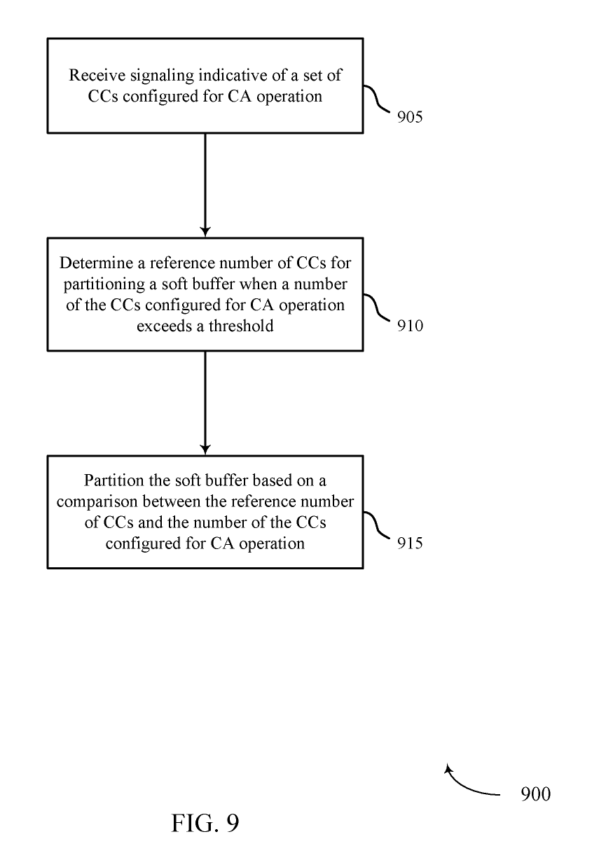

FIG. 9 shows a flowchart illustrating a method 900 for soft buffer management in eCA in accordance with various aspects of the present disclosure. The operations of method 900 may be implemented by a UE 115 or its components as described with reference to FIGS. 1-8. For example, the operations of method 900 may be performed by the eCA soft buffer manager 510 as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware.

At block 905, the UE 115 may receive signaling indicative of a plurality of CCs configured for CA operation as described herein with reference to FIGS. 2-4. In certain examples, the operations of block 905 may be performed by the CA module 605 as described herein with reference to FIG. 6.

At block 910, the UE 115 may determine a reference number of CCs for partitioning a soft buffer when a number of the CCs configured for CA operation exceeds a threshold as described herein with reference to FIGS. 2-4. In certain examples, the operations of block 910 may be performed by the reference number of CCs module 610 as described herein with reference to FIG. 6.

At block 915, the UE 115 may partition the soft buffer based on a comparison between the reference number of CCs and the number of the CCs configured for CA operation as described herein with reference to FIGS. 2-4. In certain examples, the operations of block 915 may be performed by the soft buffer partitioning module 615 as described herein with reference to FIG. 6.

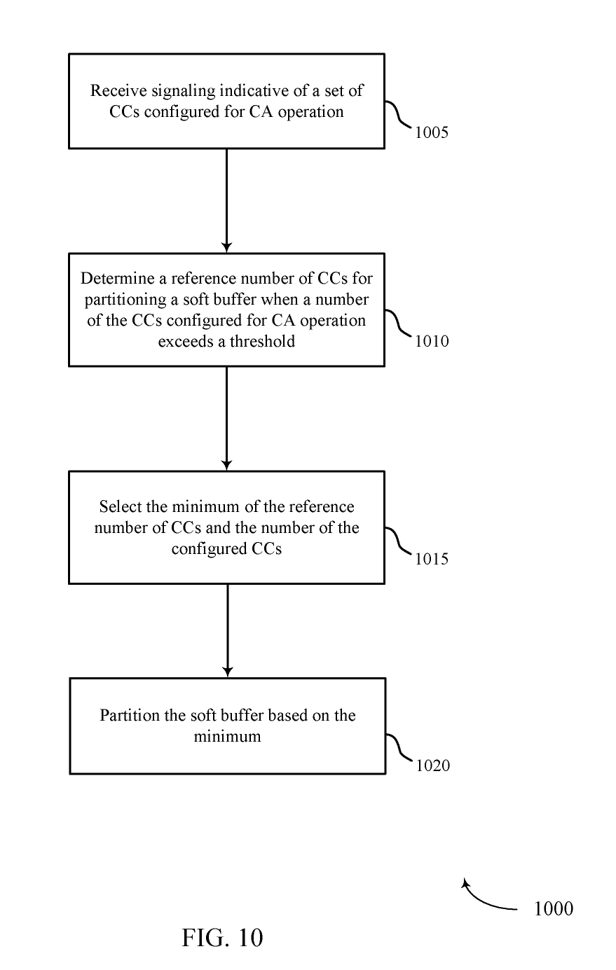

FIG. 10 shows a flowchart illustrating a method 1000 for soft buffer management in eCA in accordance with various aspects of the present disclosure. The operations of method 1000 may be implemented by a UE 115 or its components as described with reference to FIGS. 1-8. For example, the operations of method 1000 may be performed by the eCA soft buffer manager 510 as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The method 1000 may also incorporate aspects of method 900 of FIG. 9.

At block 1005, the UE 115 may receive signaling indicative of a plurality of CCs configured for CA operation as described herein with reference to FIGS. 2-4. In certain examples, the operations of block 1005 may be performed by the CA module 605 as described herein with reference to FIG. 6.

At block 1010, the UE 115 may determine a reference number of CCs for partitioning a soft buffer when a number of the CCs configured for CA operation exceeds a threshold as described herein with reference to FIGS. 2-4. In certain examples, the operations of block 1010 may be performed by the reference number of CCs module 610 as described herein with reference to FIG. 6.

At block 1015, the UE 115 may select on a minimum of the reference number of CCs and the number of the configured CCs. as described herein with reference to FIGS. 2-4. In certain examples, the operations of block 1015 may be performed by the reference number of CCs module 610 as described herein with reference to FIG. 6.

At block 1020, the UE 115 may partition the soft buffer based on the minimum as described herein with reference to FIGS. 2-4. In certain examples, the operations of block 1020 may be performed by the soft buffer partitioning module 615 as described herein with reference to FIG. 6.

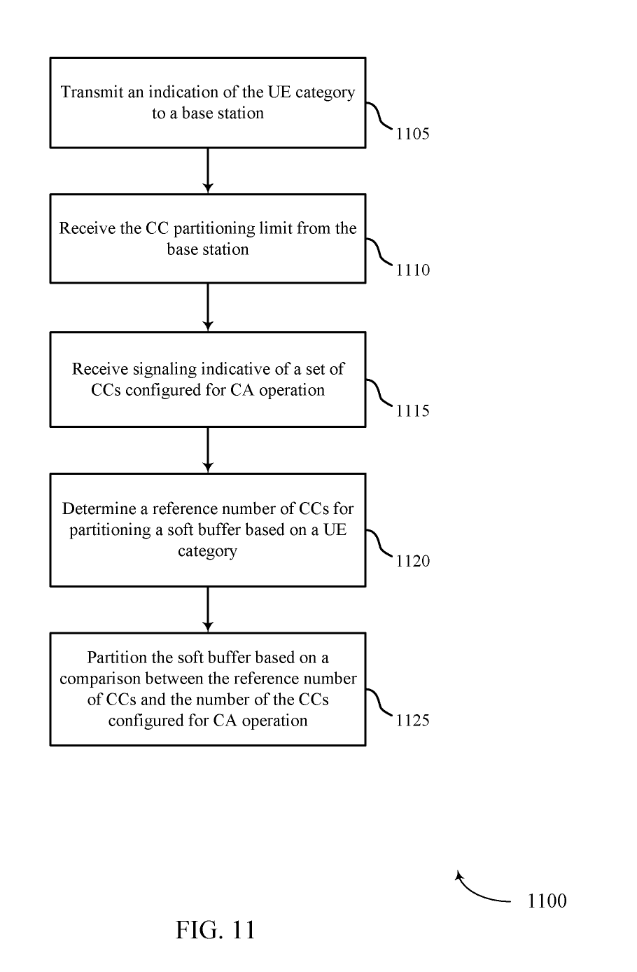

FIG. 11 shows a flowchart illustrating a method 1100 for soft buffer management in eCA in accordance with various aspects of the present disclosure. The operations of method 1100 may be implemented by a UE 115 or its components as described with reference to FIGS. 1-8. For example, the operations of method 1100 may be performed by the eCA soft buffer manager 510 as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The method 1100 may also incorporate aspects of methods 900, and 1000 of FIGS. 9-10.

At block 1105, the UE 115 may transmit an indication of the UE category to a base station as described herein with reference to FIGS. 2-4. In certain examples, the operations of block 1105 may be performed by the UE category module 705 as described herein with reference to FIG. 7.

At block 1110, the UE 115 may receive the reference number of CCs from the base station as described herein with reference to FIGS. 2-4. In certain examples, the operations of block 1110 may be performed by the receiver 505 as described herein with reference to FIG. 5.

At block 1115, the UE 115 may receive signaling indicative of a plurality of CCs configured for CA operation as described herein with reference to FIGS. 2-4. In certain examples, the operations of block 1115 may be performed by the CA module 605 as described herein with reference to FIG. 6.

At block 1120, the UE 115 may determine a reference number of CCs for partitioning a soft buffer when a number of the CCs configured for CA operation exceeds a threshold as described herein with reference to FIGS. 2-4. In some cases, determining the reference number of CCs is based on a UE category. In certain examples, the operations of block 1120 may be performed by the reference number of CCs module 610 as described herein with reference to FIG. 6.

At block 1125, the UE 115 may partition the soft buffer based on a comparison between the reference number of CCs and the number of the CCs configured for CA operation as described herein with reference to FIGS. 2-4. In certain examples, the operations of block 1125 may be performed by the soft buffer partitioning module 615 as described herein with reference to FIG. 6.

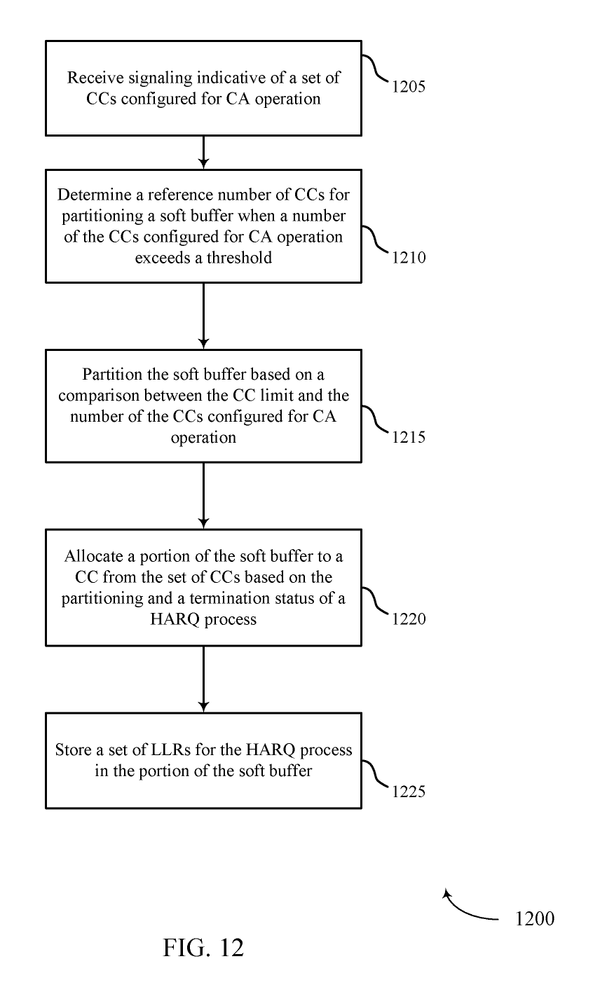

FIG. 12 shows a flowchart illustrating a method 1200 for soft buffer management in eCA in accordance with various aspects of the present disclosure. The operations of method 1200 may be implemented by a UE 115 or its components as described with reference to FIGS. 1-8. For example, the operations of method 1200 may be performed by the eCA soft buffer manager 510 as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The method 1200 may also incorporate aspects of methods 900, 1000, and 1100 of FIGS. 9-11.

At block 1205, the UE 115 may receive signaling indicative of a plurality of CCs configured for CA operation as described herein with reference to FIGS. 2-4. In certain examples, the operations of block 1205 may be performed by the CA module 605 as described herein with reference to FIG. 6.

At block 1210, the UE 115 may determine a reference number of CCs for partitioning a soft buffer when a number of the CCs configured for CA operation exceeds a threshold as described herein with reference to FIGS. 2-4. In certain examples, the operations of block 1210 may be performed by the reference number of CCs module 610 as described herein with reference to FIG. 6.

At block 1215, the UE 115 may partition the soft buffer based on a comparison between the Reference number of CCs and the number of the CCs configured for CA operation as described herein with reference to FIGS. 2-4. In certain examples, the operations of block 1215 may be performed by the soft buffer partitioning module 615 as described herein with reference to FIG. 6.

At block 1220, the UE 115 may allocate a portion of the soft buffer to a CC from the plurality of CCs based on the partitioning and a termination status of a HARQ process as described herein with reference to FIGS. 2-4. In certain examples, the operations of block 1220 may be performed by the soft buffer allocation module 710 as described herein with reference to FIG. 7.

At block 1225, the UE 115 may store a set of LLRs for the HARQ process in the portion of the soft buffer as described herein with reference to FIGS. 2-4. In certain examples, the operations of block 1225 may be performed by the LLR buffering module 715 as described herein with reference to FIG. 7.

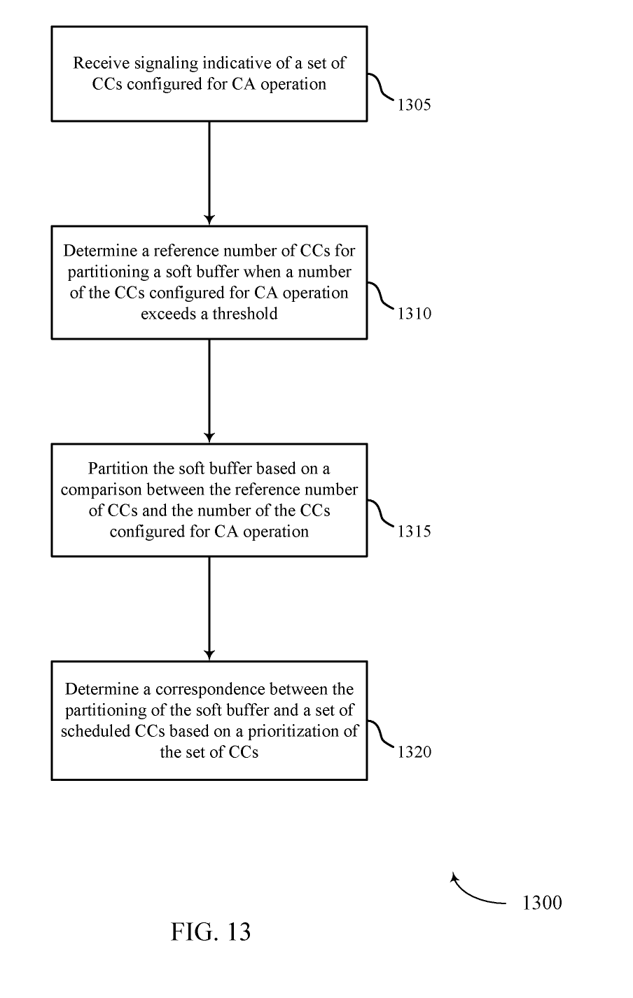

FIG. 13 shows a flowchart illustrating a method 1300 for soft buffer management in eCA in accordance with various aspects of the present disclosure. The operations of method 1300 may be implemented by a UE 115 or its components as described with reference to FIGS. 1-8. For example, the operations of method 1300 may be performed by the eCA soft buffer manager 510 as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The method 1300 may also incorporate aspects of methods 900, 1000, 1100, and 1200 of FIGS. 9-12.

At block 1305, the UE 115 may receive signaling indicative of a plurality of CCs configured for CA operation as described herein with reference to FIGS. 2-4. In certain examples, the operations of block 1305 may be performed by the CA module 605 as described herein with reference to FIG. 6.

At block 1310, the UE 115 may determine a reference number of CCs for partitioning a soft buffer when a number of the CCs configured for CA operation exceeds a threshold as described herein with reference to FIGS. 2-4. In certain examples, the operations of block 1310 may be performed by the reference number of CCs module 610 as described herein with reference to FIG. 6.

At block 1315, the UE 115 may partition the soft buffer based on a comparison between the reference number of CCs and the number of the CCs configured for CA operation as described herein with reference to FIGS. 2-4. In certain examples, the operations of block 1315 may be performed by the soft buffer partitioning module 615 as described herein with reference to FIG. 6.

At block 1320, the UE 115 may determine a correspondence between the partitioning of the soft buffer and a plurality of scheduled CCs based on a prioritization of the plurality of CCs as described herein with reference to FIGS. 2-4. In certain examples, the operations of block 1320 may be performed by the CC prioritization module 720 as described herein with reference to FIG. 7.

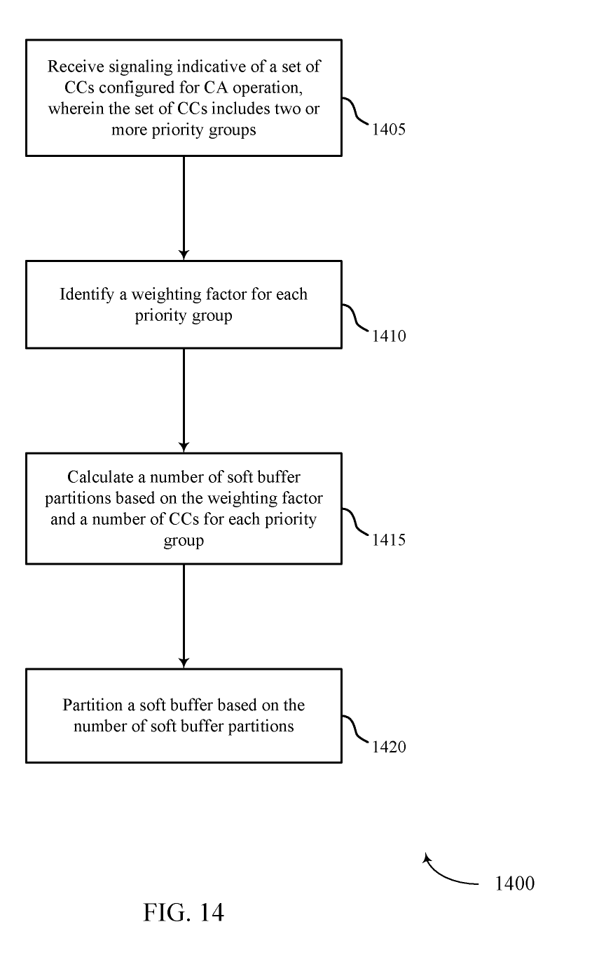

FIG. 14 shows a flowchart illustrating a method 1400 for soft buffer management in eCA in accordance with various aspects of the present disclosure. The operations of method 1400 may be implemented by a UE 115 or its components as described with reference to FIGS. 1-8. For example, the operations of method 1400 may be performed by the eCA soft buffer manager 510 as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The method 1400 may also incorporate aspects of methods 900, 1000, 1100, 1200, and 1300 of FIGS. 9-13.

At block 1405, the UE 115 may receive signaling indicative of a plurality of CCs configured for CA operation, where the plurality of CCs may include two or more priority groups as described herein with reference to FIGS. 2-4. In certain examples, the operations of block 1405 may be performed by the CA module 605 as described herein with reference to FIG. 6.

At block 1410, the UE 115 may identify a weighting factor for each priority group and a reference number of CCs for each priority group as described herein with reference to FIGS. 2-4. In certain examples, the operations of block 1410 may be performed by the CC prioritization module 720 as described herein with reference to FIG. 7.

At block 1415, the UE 115 may calculate a number of soft buffer partitions based on the weighting factor and a number of CCs for each priority group as described herein with reference to FIGS. 2-4. In certain examples, the operations of block 1415 may be performed by the soft buffer partitioning module 615 as described herein with reference to FIG. 6.

At block 1420, the UE 115 may partition a soft buffer based on the number of soft buffer partitions as described herein with reference to FIGS. 2-4. In certain examples, the operations of block 1420 may be performed by the soft buffer partitioning module 615 as described herein with reference to FIG. 6.

Thus, methods 900, 1000, 1100, 1200, 1300, and 1400 may provide for soft buffer management in eCA. It should be noted that methods 900, 1000, 1100, 1200, 1300, and 1400 describe possible implementation, and that the operations and the steps may be rearranged or otherwise modified such that other implementations are possible. In some examples, aspects from two or more of the methods 900, 1000, 1100, 1200, 1300, and 1400 may be combined.

The detailed description set forth above in connection with the appended drawings describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “ or ” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method of wireless communication, comprising:
receiving signaling indicative of a first number of component carriers (CCs) configured for carrier aggregation (CA) operation;
determining a reference number of CCs for partitioning a soft buffer when the first number of CCs configured for CA operation exceeds a threshold; and
partitioning the soft buffer based at least in part on the reference number of CCs.

2. The method of claim 1, wherein the partitioning is based at least in part on a minimum of the reference number of CCs and the number of the configured CCs.

3. The method of claim 1, wherein determining the reference number of CCs is based at least in part on a user equipment (UE) category.

4. The method of claim 3, further comprising:
transmitting an indication of the UE category to a base station; and
receiving an indication of the reference number of CCs from the base station.

5. The method of claim 1, wherein determining the reference number of CCs is based at least in part on the number of the configured CCs.

6. The method of claim 1, wherein the reference number of CCs is based at least in part on a size of the soft buffer.

7. The method of claim 6, wherein the size of the soft buffer is associated with a UE category, and the reference number of CCs is less than a maximum number of CCs supported by the UE category.

8. The method of claim 1, further comprising:
allocating a portion of the soft buffer to a CC from the first number of CCs based at least in part on the partitioning and a termination status of a hybrid automatic repeat request (HARQ) process; and
storing a set of log-likelihood ratios (LLRs) for the HARQ process in the portion of the soft buffer.

9. The method of claim 1, wherein partitioning the soft buffer comprises:
identifying at least one of a number of code blocks, a soft buffer size for a code block at a base station, a number of HARQ processes, a HARQ process limit, or any combination thereof.

10. The method of claim 1, wherein the threshold is five CCs.

11. The method of claim 1, further comprising:
determining a correspondence between the partitioning of the soft buffer and a plurality of scheduled CCs based at least in part on a prioritization of the first number of CCs.

12. The method of claim 1, wherein the first number of CCs are grouped into at least a primary group and a secondary group, wherein each group comprises at least one CC from the first number of CCs.

13. The method of claim 12, wherein the primary group and the secondary group are part of a dual-connectivity operation.

14. The method of claim 1, wherein the first number of CCs comprises two or more priority groups, the method further comprising:
identifying a weighting factor for each priority group and a reference number of CCs for each priority group;
calculating a number of soft buffer partitions based at least in part on the weighting factor and the reference number of CCs for each priority group; and
partitioning a soft buffer based at least in part on the number of soft buffer partitions.

15. An apparatus for wireless communication, comprising:
means for receiving signaling indicative of a first number of component carriers (CCs) configured for carrier aggregation (CA) operation;
means for determining a reference number of CCs for partitioning a soft buffer when the first number of CCs configured for CA operation exceeds a threshold; and
means for partitioning the soft buffer based at least in part on the reference number of CCs.

16. The apparatus of claim 15, wherein determining the reference number of CCs is based at least in part on a user equipment (UE) category.

17. The apparatus of claim 15, further comprising:
means for allocating a portion of the soft buffer to a CC from the first number of CCs based at least in part on the partitioning and a termination status of a hybrid automatic repeat request (HARQ) process; and
means for storing a set of log-likelihood ratios (LLRs) for the HARQ process in the portion of the soft buffer.

18. The apparatus of claim 15, wherein the means for partitioning the soft buffer comprises:
means for identifying at least one of a number of code blocks, a soft buffer size for a code block at a base station, a number of HARQ processes, a HARQ process limit, or any combination thereof.

19. The apparatus of claim 15, further comprising:
means for determining a correspondence between the partitioning of the soft buffer and a plurality of scheduled CCs based at least in part on a prioritization of the first number of CCs.

20. The apparatus of claim 15, wherein the first number of CCs are grouped into at least a primary group and a secondary group, wherein each group comprises at least one CC from the first number of CCs.

21. The apparatus of claim 15, wherein the first number of CCs comprises two or more priority groups, the apparatus further comprising:
means for identifying a weighting factor for each priority group and a reference number of CCs for each priority group;
means for calculating a number of soft buffer partitions based at least in part on the weighting factor and the reference number of CCs for each priority group; and
means for partitioning a soft buffer based at least in part on the number of soft buffer partitions.

22. An apparatus for wireless communication, comprising:
a processor;
memory in electronic communication with the processor; and
instructions stored in the memory and operable, when executed by the processor, to cause the apparatus to:
receive signaling indicative of a first number of component carriers (CCs) configured for carrier aggregation (CA) operation;
determine a reference number of CCs for partitioning a soft buffer when the first number of CCs configured for CA operation exceeds a threshold; and
partition the soft buffer based at least in part on the reference number of CCs.

23. The apparatus of claim 22, wherein the instructions are operable to cause the apparatus to:
allocate a portion of the soft buffer to a CC from the first number of CCs based at least in part on the partitioning and a termination status of a hybrid automatic repeat request (HARQ) process; and
store a set of log-likelihood ratios (LLRs) for the HARQ process in the portion of the soft buffer.

24. The apparatus of claim 22, wherein the instructions operable to cause the apparatus to partition the soft buffer comprise instructions operable to cause the apparatus to:
identify at least one of a number of code blocks, a soft buffer size for a code block at a base station, a number of HARQ processes, a HARQ process limit, or any combination thereof.

25. The apparatus of claim 22, wherein the threshold is five CCs.

26. The apparatus of claim 22, wherein the first number of CCs comprises two or more priority groups, the instructions being further operable to cause the apparatus to:
identify a weighting factor for each priority group and a reference number of CCs for each priority group;
calculate a number of soft buffer partitions based at least in part on the weighting factor and a number of CCs for each priority group; and
partition a soft buffer based at least in part on the number of soft buffer partitions.

27. A non-transitory computer-readable medium storing code for wireless communication, the code comprising instructions executable to:
receive signaling indicative of a first number of component carriers (CCs) configured for carrier aggregation (CA) operation;
determine a reference number of CCs for partitioning a soft buffer when the first number of CCs configured for CA operation exceeds a threshold; and
partitioning the soft buffer based at least in part on the reference number of CCs.

28. The non-transitory computer-readable medium of claim 27, wherein the reference number of CCs is based at least in part on a size of the soft buffer.

29. The non-transitory computer-readable medium of claim 28, wherein the size of the soft buffer is associated with a UE category, and the reference number of CCs is less than a maximum number of CCs supported by the UE category.

30. The non-transitory computer-readable medium of claim 27, wherein the first number of CCs comprises two or more priority groups, and wherein the code further comprises instructions executable to:
identify a weighting factor for each priority group and a reference number of CCs for each priority group;
calculate a number of soft buffer partitions based at least in part on the weighting factor and the reference number of CCs for each priority group; and
partition a soft buffer based at least in part on the number of soft buffer partitions.
